(19) United States
(12) Patent Application Publication
(10) Pub. No.: US 2014/0176694 A1
(43) Pub. Date: Jun. 26, 2014

(54) Imaging system

(71) Applicants: Michael Mermelstein, Cambridge, MA (US); Charles Cameron Abnet, Waltham, MA (US)

(72) Inventors: Michael Mermelstein, Cambridge, MA (US); Charles Cameron Abnet, Waltham, MA (US)

(21) Appl. No.: 14/099,088

(22) Filed: Dec. 6, 2013

Related U.S. Application Data
(60) Provisional application No. 61/797,413, filed on Dec. 6, 2012.

(51) Int. Cl. G02B 21/36

(52) U.S. Cl. CPC G02B 21/365
USPC 348/79

(57) ABSTRACT

The invention provides an novel imaging system for microscopy including both continuous motion and stationary field image acquisition. More specifically, the invention provides a system that can translate a specimen relative to the field-of-view of an imager while synchronously acquiring image data. Using the same imaging optics and imager, the system can acquire stationary images at any location on the specimen.

### CROSS-REFERENCE TO RELATED APPLICATIONS

This application claims the benefit of provisional patent application Ser. No. 61/797,413, filed Dec. 6, 2012.

### FEDERALLY SPONSORED RESEARCH

Not applicable

### SEQUENCE LISTING OR PROGRAM

Not applicable

### FIELD OF THE INVENTION

This invention relates to an imaging system and particularly to a system used to image cells and cellular structures.

### BACKGROUND OF THE INVENTION

Imaging systems are used in a large number of industries and are particularly important in cellular biology where they are used to observe cells and cell structures in an effort to improve understanding of cellular function. Ultimately, these systems play an important role in the development of new drugs and disease treatments.

In general, cell researchers want to observe a large number of cells, which requires a large image area, and they want to observe cellular responses and features among individual cells, which requires sufficient image resolution to differentiate cells and even sub-cellular structures. Industry has struggled to fulfill these needs in a single imaging system.

Typical prior art systems either observe a large population of cells at a low resolution, insufficient to observe sub-cellular features, or collect high resolution images of a much smaller sample population of cells. Unfortunately, high resolution imaging of a large of number of cells increases the time needed for image collection and the volume of data to process, thus reducing the practicality of this approach. Systems that can collect high resolution images of large areas, that can process such images, and that can do so in a useful time-frame, come at a great expense that limits their wide-spread use.

It is commonly the case that a cellular specimen will have areas of lesser and greater interest for imaging at high resolution. So it is desirable for a system to image an entire specimen rapidly at a lower resolution and then to image areas of greater interest with higher resolution. Thus, such a system spends the time and data costs of higher resolution on a smaller total area. This process is sometimes referred to as “mark and find” and is particularly desirable when finding a rare cell type or rare cellular response. Prior art systems have attempted to provide this capability by using a first optical system with a low magnification and then using a second, higher magnification system to examine areas of greater interest (e.g. they might first image with a 2× objective lens and return to a location with a 10× objective lens). These systems are optically complex and are prone to misalignment of the two optical systems, requiring additional expense or calibration. Thus, prior art mark and find systems have had limited success in automated applications.

There is a need for a new imaging system capable of observing a large number of cells quickly and with a resolution sufficient to observe cellular features. The present invention addresses this need using a novel method and provides other useful features.

### SUMMARY OF THE INVENTION

The present invention provides a system and method for imaging a specimen. In its preferred embodiment, the system uses a CCD camera, image forming optics with a high numerical aperture objective lens, and mechanical translation stages. This system captures images of a specimen in two modes.

In a first mode, a specimen is moved through the imaging field of view of the camera by the stages. The system constructs a continuous image stripe during continuous motion of the specimen along its path. The camera integrates incoming light to form each portion of the image stripe. The integration is synchronized with the translation of the specimen and can also include synchronized strobed illumination. This mode provides rapid imaging of a large area with a high numerical aperture (relative to the image area). In the preferred embodiment, the imaging system is used with a specimen having a number locations of interest such as the wells containing cells in a microtiter plate. To increase the sensitivity to light and speed of the CCD camera, and to reduce the volume of image data to be transmitted and processed, the CCD camera is typically operated in a binning mode during image stripe collection. Thus, the high-speed image collected in the first mode is of a lower resolution.

In a second mode, the system captures a stationary image at a location on the specimen. Unlike prior-art imaging systems, this system mode provides stationary imaging capability using the same optical arrangement—i.e. the same high numerical aperture objective lens. Thus, portions of a specimen located during a continuous scan can be located exactly and imaged statically at higher resolution.

This combination of continuous scanning and stationary field imaging provides a number of novel capabilities. For example, a path producing scanned and/or stationary images can gate additional scanned and/or stationary images along the same or different paths.

In addition, the preferred embodiment takes advantage of the standardized format of microtiter plates. Using a predetermined map of the wells, acquired images are segmented and quantified. This allows precise location of cells and cellular events within the plates. It will be clear to those skilled in the art that additional specimen types apart from collections of cells are within the scope of the present invention.

Further objects and advantages will become apparent from the detailed descriptions that follow.

### BRIEF DESCRIPTION OF THE DRAWINGS

FIG. 1 shows a preferred embodiment of a typical specimen with predetermined wells containing cells.

FIG. 2 shows schematically a preferred embodiment of an imaging system including a means for translating a specimen relative to an optical imaging configuration.

FIG. 3 shows a front view of an optical configuration and a microtiter plate translating relative to the optical configuration.

FIG. 4 shows steps in the construction of a first image from a translation trajectory and segmentation of the image.

FIG. 5 shows a complete scan of several wells by constructing a composite image of several images and a stationary image. The resulting image is additionally segmented into subimages.

FIG. 6 shows a collection of image trajectories and stationary field images overlaid on a specimen with predetermined wells.

FIG. 7 shows a collection of useful translation trajectories.

FIG. 8a-FIG. 8b show details of a process for optically aligning a specimen relative to the imaging system.

### DETAILED DESCRIPTION

The preferred embodiment of the present imaging system consists of a mechanical translation stage to move a specimen relative to an optical configuration. The optical configuration is positioned to image a portion of the specimen and to provide illumination if needed. Control of both the specimen translation and image capture are provided by custom control electronics and a computer with custom image acquisition and analysis software.

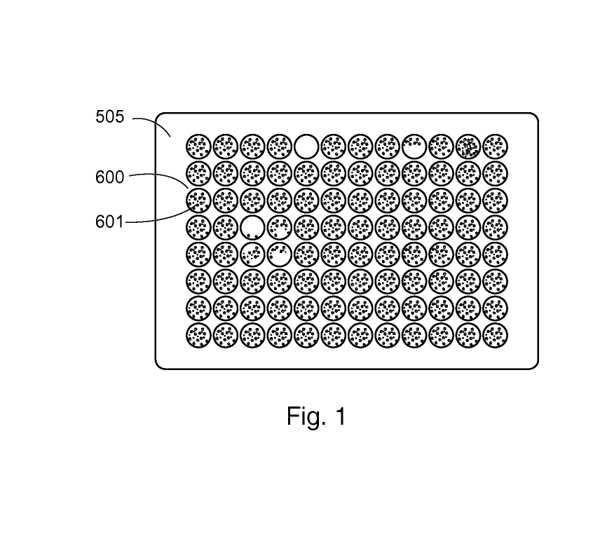

Mechanical and optical system The preferred specimen imaged by the present invention is shown in FIG. 1. The specimen is an industry-standard microtiter plate 505 with an array of wells 600 (in this case 96 wells) designed to contain a collection of cells 601 for experimentation and subsequent imaging. Often, the cells will be labeled by a fluorescent marker that emits a predetermined color of light when illuminated by a different color of light.

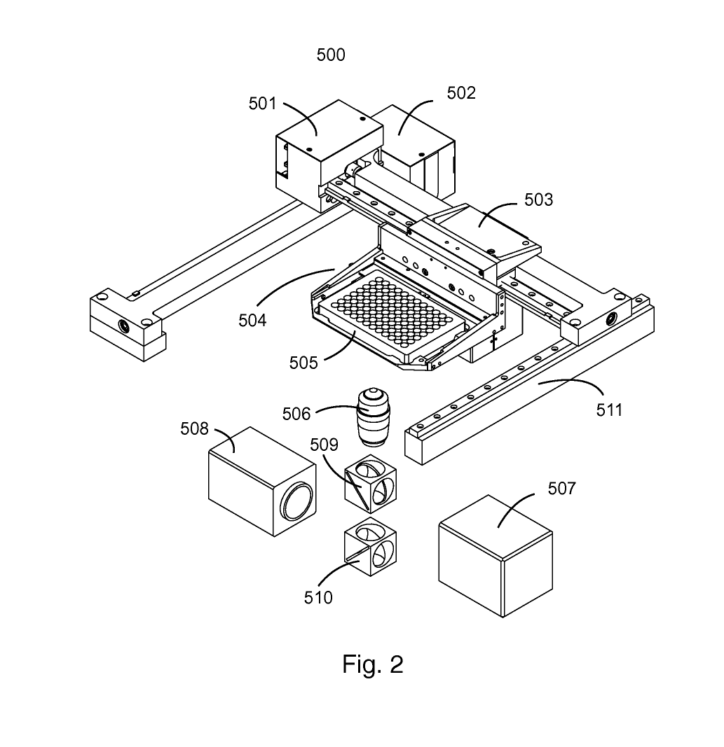

The preferred mechanical and optical components of the present imaging system 500 are arranged and shown in FIG. 2. A microtiter plate with wells 505 is mounted on a platform 504 that is mechanically positioned in three dimensions by controllable linear translation stages 501, 502, and 503 relative to a stationary objective lens 506. Additional mechanical support for translation stage 501 is provided by the rail 511.

The objective lens 506 is held beneath the microtiter plate 505 by a optical mounting means (not shown) that additionally mounts and aligns beamsplitter 509 and mirror 510, as well as a CCD camera 508 and a controllable illumination source 507.

It is advantageous to employ an objective lens 506 of a high numerical aperture. Such a lens has high resolution and high efficiency for collecting light. However, as the numerical aperture is increased, the optical system requires increasingly precise focus. A 10× 0.45 NA objective lens, in combination with a CCD camera with 5 micron square pixels provides sub-cellular resolution sufficient for many applications, a reasonable field of view, a practical working distance, and excellent light collection compared to typical whole-well imaging optical systems.

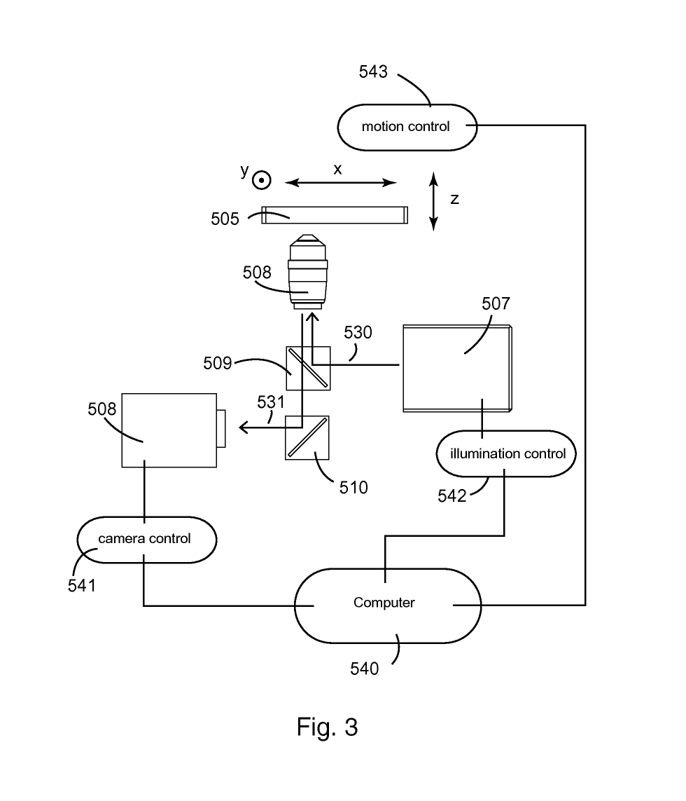

In operation, a computer 540, shown in FIG. 3, sends control instructions to motion control hardware 543. The motion control moves the specimen 505 into a predetermined position relative to the objective lens. The motion of the specimen may include a combination of motion (Z) along the optical axis of the objective to focus portions of the specimen, as well as translation (X,Y) in the plane orthogonal to the optical axis. For efficiency, these motions are carried out simultaneously. In general, the optical properties of the specimen affect the translation requirements and the ability to acquire continuous images. An ideal specimen is optically flat and requires no focus adjustment (motion along the optical axis) during translation. However, non-ideal specimens can be handled by adjusting focus continuously during X,Y translation.

When the specimen is in a desired location relative to the objective lens, a command is sent to the illumination control 542 to provide light 530 of a suitable color, intensity, and duration. At substantially the same time, a command is sent to the camera control 541 to integrate incoming light 531. Image data are read out of the camera, stored in the memory of computer 540, and then processed.

In an additional embodiment, cells or other structures within the specimen wells are luminescent structures, producing their own light, and do not require a controlled illumination source. In this case, the camera is commanded to begin integration when the specimen is in a desired location as determined by dead-reckoning or previous imaging. Integration ends after a predetermined amount of time, for example using a form of electronic shuttering.

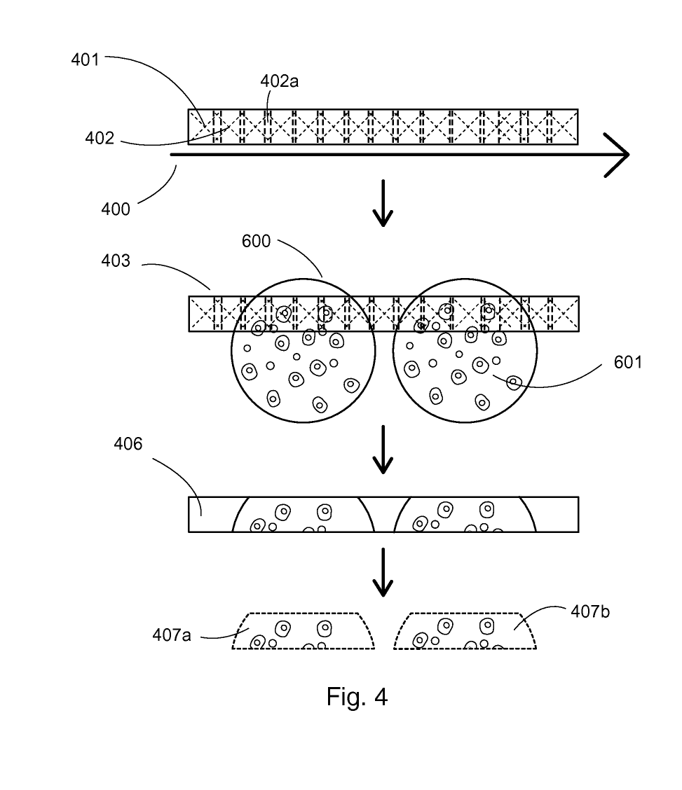

Constructing an image with continuous motion The process of constructing an image from continuous scanning operations uses image stripes and is shown in FIG. 4. A linear translation substantially orthogonal to the optical axis of the objective lens is symbolized by the arrow 400.

The preferred embodiment employs an area imaging CCD. The motion of the scene can impart blur to a CCD image in several ways. In one embodiment, motion blur is mitigated by employing a Time Delayed Integration (TDI) mode in the CCD. In another embodiment, just the bottom line of the CCD is read out, and the remaining lines are optically masked or electronically dumped, providing a line-scan camera capability in this mode of operation. CMOS or other area image sensors offer yet more possibilities for continuous motion scanning. For example, many can be selectably read out in sub-windows, simplifying a line-scan approach, or enabling a window-shifting method, for example to align frame boundaries of a series of frames.

In the simplest form, however, a CCD is read out conventionally in frames, as shown in FIG. 4. During the translation, the CCD camera acquires frames of imagery. Generally, such frames will suffer from motion-related blur. Even a significantly blurred image can contain useful information, however. For example, it is possible to determine the center of a blurry bright spot accurately to a fraction of its blurred size. For another example, wells of greater brightness can be identified in the face of blur on the scale of many cells. However, it is typically desirable to mitigate motion blur by limiting the integration time for each frame—either by electronic shuttering or by pulsed illumination, for example.

The first two frames acquired in translation 400 are represented as graphical compartments 401 and 402 where each frame's field of view within the specimen is centered on a dotted ‘X’ and separated by dotted lines. In this case, each frame overlaps with adjoining frames. A representative overlap is indicated as 402a. Because translation stages typically accelerate and decelerate during translation, these frames may overlap each other to varying degrees, as shown.

The product of this process is represented by stripe 403 shown overlaid on two specimen wells (600 and 601) for clarity. In this case, the specimen was translated relative to the objective lens, a continuous sequence of integration periods were captured, and the system imaged a stripe 403 across the wells. The completed stripe is represented by image 406 where image analysis in the computer has stitched together a continuous stripe from the overlapping frames. A priori knowledge of the specimen well locations provides a map to segment the image stripe into portions corresponding to the wells as shown by subimages group 407a and 407b.

Continuous image stripes and stationary field images A unique feature of the present invention is the acquisition of stationary field images in conjunction with continuous motion imaging using a single objective lens and an area imaging CCD.

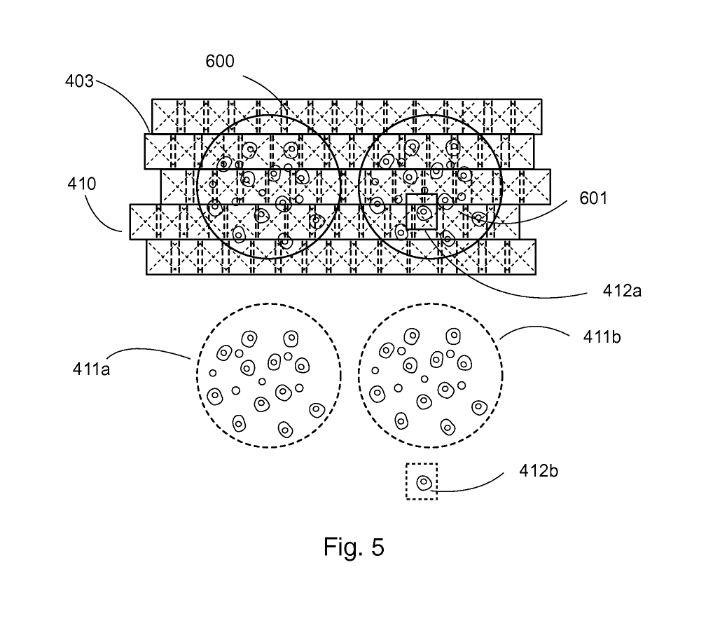

FIG. 5 shows two specimen wells entirely overlaid by five image stripes to form a large area image 410. The complete segmentation of the large area image is shown as items 411a and 411b where the wells 600 and 601 are mapped and represented for clarity by dotted lines. The figure also shows an example of “mark-and-find” where region 412a is selected and statically imaged to capture the details of a single cell in static image 412b.

The static image 412b will not suffer from motion-related degradation such as motion blur. Moreover, the static image may be collected with different imaging parameters such as lesser binning, a longer exposure time, different optical contrast modes, or different illumination wave-lengths compared with the large area image. Examples of different optical contrast modes include epi-fluorescence, darkfield illumination, brightfield illumination, interference contrast, structured illumination, multi-photon, and confocal imaging modes. Thus, the static image might provide, in general, more information compared with the corresponding portion of large area image. Specifically, it could provide higher spatial, spectral, or photometric resolution, for example.

Importantly, due to the use of a single optical system (e.g. the same objective lens) for both images in the preferred embodiment, the coordinates of region 412a in the coordinate system of the translation stages will be unchanged from the large area image to the static image. Thus a higher-speed, lower-resolution, large-area image precisely informs the choice and location of region for a higher-resolution image.

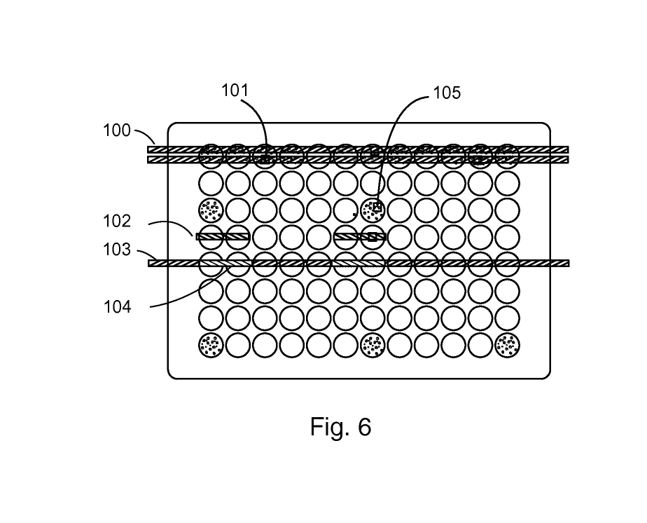

More generally, FIG. 6 shows a variety of image stripes, items 100, 102, and 103, spanning multiple wells at multiple locations. Along with these stripes, stationary field images are highlighted as boxes. Several stationary images are labeled as 101 and 105. There are a number of combinations of scans and stationary images represented. For example, image stripes 100 represent continuous imaging with several stationary images at specific locations along the translation path. The relative timing of the scan and the stationary image can be independent of or dependent on one another. For example, an image stripe path can include a pause to capture a stationary image field at regular or predefined intervals. In this case, the stationary images are independent of the image stripe. In another example, the analysis of an image stripe can trigger a subsequent stationary image. The analysis of the image stripes of 100 might reveal several areas where a stationary image with a longer exposure time or different illumination parameters could reveal important details. In this case, the stationary image location and characteristics are dependent on the image stripe. Alternatively, a stationary image such as 105 can be captured, analyzed, and produce results that then trigger a more complete area scan using image stripes near image 105 or at other distant locations.

In an additional embodiment, a continuous motion stripe can be carried out using a variety of parameters that vary along the translation path. For example, stripe 103 has several portions, such as 104 spanning two wells and uniquely hatched, representing a continuous stripe image with a variety of different imaging parameters. For example, portion 104 might have a continuous velocity slower than other contiguous portions of the stripe 103. A slower velocity portion can be used to increase the effective integration period (and thus, the sensitivity to dim targets) for the specimen area within that portion. Alternatively, section 104 can represent a portion having different illumination parameters than other portions of stripe 103. For example, given an array of cellular experiments in a microtiter plate, it might be advantageous to illuminate 104 with higher illumination intensity and remaining portions of stripe 103 with lower illumination intensity.

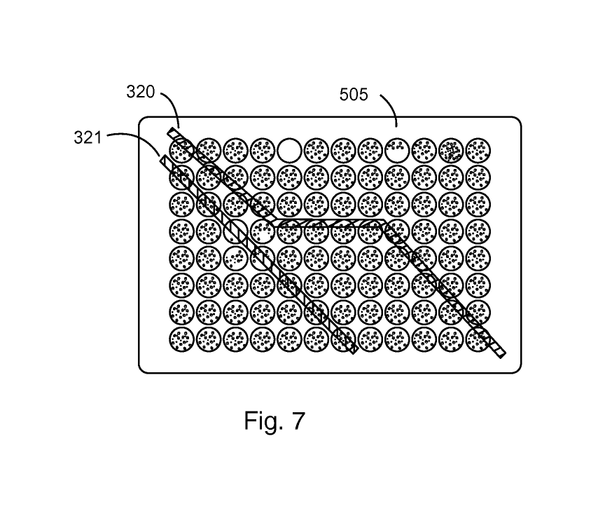

FIG. 7 uses several hatched paths overlaying plate 505 to depict a variety of predetermined translations capable of sampling a variety of plated experiments laid out in a variety of spatial arrangements. For example, a plate might be arranged so that every well or every third well has a new set of experimental parameters. Different translation trajectories can sample different experimental combinations more rapidly. Path 321 images diagonally through the center of seven specimen wells, one well in each of seven rows. Path 320 traverses portions of multiple wells in multiple rows.

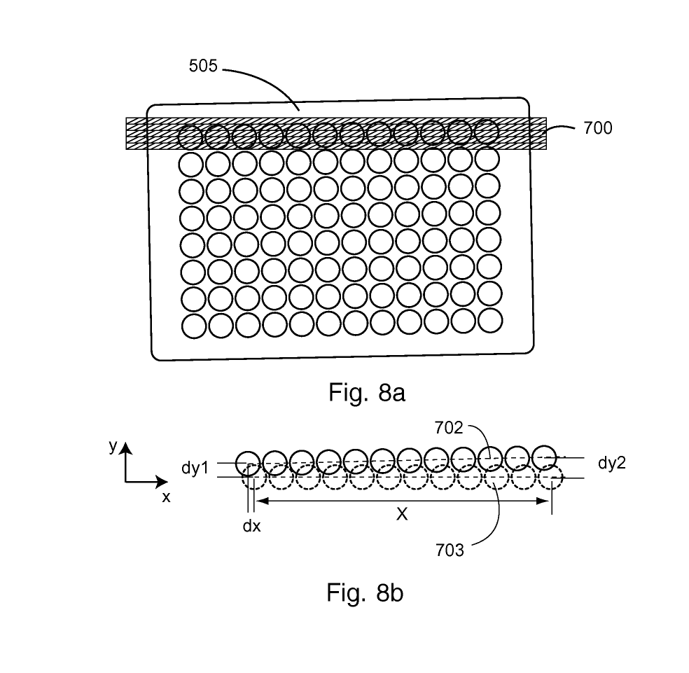

Specimen alignment Many of the translation paths disclosed require precision mechanical motions and optical alignment with the specimen. In addition, it is important to determine the location of wells in order to locate specific structures or populations, as well as to segment images into appropriate subimages. Continuously imaging along a trajectory provides a rapid sample of well position that can be used for aligning the physical specimen with a known geometry or model. FIG. 8a depicts a microtiter plate 505 and the trajectory of five image stripes 700 traversing the top row of wells. In this case, an illumination mode such as brightfield or suitable fluorescent labeling is used to provide sufficient contrast to locate the boundary of a number of wells. FIG. 8b shows measured boundaries of wells 702 (sequence of circles with solid line perimeter) relative to a model of well locations (circles with a dotted line perimeter) with a known orientation relative to the CCD camera and translation stages. For example, the imaged wells are rotated by a slope approximated by the ratio of (dy2−dy1) to the row length X, an x offset of dx and a y offset of dy1. These offsets are computed and used in subsequent segmentation of images so that quantitative measures are attributed to appropriate wells and/or experimental conditions.

Additional alternative designs and assemblies are within the scope of this disclosure and although several are described they are not intended to define the scope of the invention or to be otherwise limiting.

We claim:

1. A system for imaging a specimen comprising
controllable image sensing means having a field of view
controllable translating means
a controller configured in a first mode to control the translating means to translate the specimen relative to the field of view along a trajectory and synchronously to control the image sensing means to sense a first image of a first portion of the specimen, said controller further configured in a second mode to control the translating means to position the specimen relative to the field of view in a stationary position and further to control the image sensing means to sense a second image of a second portion of the specimen.

2. The system of claim 1 wherein said first image comprises a portion of the specimen spanning more than one field of view along said trajectory

3. The system of claim 2 wherein said first image comprises a composite image comprising said more than one field of view

4. The system of claim 1 wherein said controllable image sensing means comprises controllable imaging parameters taken from the list including: binning, exposure time, illumination wavelength, detection wavelength, magnification, optical contrast mode

5. The system of claim 1 wherein said controllable image sensing means comprises an objective lens used to sense said first image and also used to sense said second image

6. The system of claim 1 wherein said controllable image sensing means comprises image gating means

7. The system of claim 6 wherein said image gating means comprises means selected from the list including a mechanical shutter, an electronic shutter, illumination means configured to provide a controllable pulse of illumination

8. The system of claim 1 wherein said specimen comprises a specimen carrier selected from the list including multi-well plate, microtiter plate, microarray chip, microfluidic chip, microscope slide, culture dish.

9. The system of claim 1 wherein said specimen comprises a plurality of predetermined locations and wherein said system further comprises an image segmenting means configured to segment said first image into at least one sub-image corresponding to at least one of said predetermined locations.

10. The system of claim 1 wherein said stationary position is responsive to said first image.

11. A method for obtaining a first and a second image of a specimen comprising the steps of
providing controllable image sensing means having a field of view
providing controllable translating means
controlling the translating means to translate the specimen relative to the field of view along a trajectory and synchronously controlling the image sensing means to sense a first image of a first portion of the specimen
controlling the translating means to position the specimen relative to the field of view in a stationary position and further to control the image sensing means to sense a second image of a second portion of the specimen.

12. The method of claim 11 wherein said first image comprises a portion of the specimen spanning more than one field of view along said trajectory

13. The method of claim 12 wherein said first image comprises a composite image comprising said more than one field of view

14. The method of claim 11 wherein said controllable image sensing means comprises controllable imaging parameters taken from the list including: binning, exposure time, illumination wavelength, detection wavelength, magnification, optical contrast mode

15. The method of claim 11 wherein said controllable image sensing means comprises an objective lens used to sense said first image and also used to sense said second image

16. The method of claim 11 wherein said controllable image sensing means comprises image gating means

17. The method of claim 16 wherein said image gating means comprises means selected from the list including a mechanical shutter, an electronic shutter, illumination means configured to provide a controllable pulse of illumination

18. The method of claim 11 wherein said specimen comprises a specimen carrier selected from the list including multi-well plate, microtiter plate, microarray chip, microfluidic chip, microscope slide, culture dish.

19. The method of claim 11 wherein said specimen comprises a plurality of predetermined locations and wherein said method further comprises the step of segmenting said first image into at least one sub-image corresponding to at least one of said predetermined locations.

20. The method of claim 11 wherein said stationary position is responsive to said first image.

21. The method of claim 20 wherein said stationary position is the position of a cell having statistical rarity among other cells.
